(19) United States
(12) Patent Application Publication
(10) Pub. No.: US 2002/0089713 A1
(43) Pub. Date: Jul. 11, 2002

(54) Method and device for checking the operativeness of an optical transmission link

(76) Inventors: Alfred Schwandner, Metzels (DE); Uwe Groschner, Metzels (DE)

Correspondence Address: Russell D. Culbertson, Shaffer & Culbertson, L.L.P., Building One, Suite 360, 1250 Capital of Texas Hwy. S., Austin, TX, 78746, US

(21) Appl. No.: 09/994,381

(22) Filed: Nov. 26, 2001

(30) Foreign Application Priority Data
Nov. 27, 2000 (DE) 100 58 776.3

(51) Int. Cl. H04B 10/08; H04B 10/12

(52) U.S. Cl. 359/110; 359/173

(57) ABSTRACT

The invention relates to a method of checking the operativeness of a transmission link. Here, a test signal received from a first station is replied to with a response signal which differs from the test signal in its property to be evaluated.

The present invention relates to a method of checking the operativeness of an optical transmission link according to the preamble of claim 1 and to a device for carrying out the method according to claim 10.

In a generally known way, a transmitting and receiving device according to the prior art performs the function of a converter or a repeater amplifier. Here, input or received signals, which may be of the optical or also of the electric kind, are amplified, regenerated or converted in order to further process or to further transmit them. For example, such a transmitting and receiving device may be arranged between a local area network (LAN) and a wide area network (WAN) in order to convert the transmission of data from one optical wave length to another. Furthermore, a transmitting and receiving device of this kind may also be used for signal regeneration or as an amplifier unit within wide area networks. Moreover, transmitting and receiving devices of this kind are used in order to convert electric signals supplied from outside into optical signals or vice versa. It is expedient to couple two or more of these transmitting and receiving devices with one another along a transmission link in order to make communication between them possible.

Usually, optical data transmission is effected via optical waveguides at wavelengths of 1310 nm in local area networks or 1550 nm for larger distances, for example. Here, transmission rates of 2.5G Bit are achieved. Data to be transmitted and received can be transmitted via one common optical waveguide or via separate optical waveguides. When data are transmitted via one common optical waveguide, signals to be transmitted and signals to be received are separated by a selective coupler in front of the input port and behind the output port of a transmitting and receiving station or also within such a station.

Methods of checking transmission links are known from general practice. They are carried out when initially operating data transmission devices, but also when data transmission has been interrupted, in order to ensure that proper communication between two or more transmitting and receiving stations can be taken up.

For optical data transmission, high transmitting power is sometimes used. The light signals emitted in this case, which are usually transmitted from one station to the other via one or several optical waveguides, may become hazardous for the human eye if the eye is exposed to this kind of radiation for a specific time period. For example, this may happen if an optical waveguide which is in use is cut through during road works or civil engineering works and a person examines the damaged cable. Furthermore, in case of an intentional disconnection of the line, for example when disconnecting a plug-in-connection of an optical waveguide, this radiation may be emitted and may fall into the human eye. In order to avoid the danger of any damage to the eye, in case of line rupture or any other unintentional disconnection of the line, it is common practice to stop transmission immediately after the detection of this transmission line breakdown.

In order to resume transmission after such an interruption or in order to initially operate the system, the operativeness of the transmission link has to be examined first. In practice, this is done by sending out test signals (such as impulse sequences) whose nature and duration (for example, a pulse duration of less than 5 ms) is defined by laser protection classes. For this purpose, a test signal in the sense of a request is introduced into the transmission link by a first transmitting and receiving station so as to be received by a second station of this kind in case the transmission path is intact at least in this direction.

As soon as it has received and evaluated a test signal of this kind, the second station sends back this same signal to the first station as a response signal in the other direction of the transmission link. The first station will not resume transmission until a signal interpreted as the corresponding response is received, because the test signal sent out and a response signal received subsequently are rated as an indication to the fact that the transmission link is in good order.

In the prior art, such test signals are sent out at predetermined time intervals and with a fixed duration of 2 ms, for example. Within a specific period of time (time frame) after emitting a test signal, a signal from the other station has to be received as response in order to indicate that the transmission link is operative. Here, the test signal is not different from the response signal; what is decisive is that the requesting station receives a response signal within the given period of time after emitting the test signal.

What is disadvantageous here, however, is the danger that a signal interpreted as a response by a first station was actually only a test signal which had been emitted by a second station in order to check the transmission link for its operativeness, as well. In this case, the first station would resume transmission after the apparent confirmation of operativeness by the other station, although the test signal it has emitted has potentially never reached the second station—because of a line rupture of an optical waveguide, for example. In this case, radiation which is of high energy and might be hazardous would emerge at the point of rupture.

In practice, it is intended to minimize this problem by determining by coincidence the points of time at which one station emits a test signal and expects a response signal within the period of time expiring. This is intended to avoid that individual stations emit test signals in potentially equal cycles and, in an unfavourable case, at similar points of time, which might erroneously be interpreted as response signals. However, this solution does not provide complete safety from “misunderstandings” of this kind, because points of time of transmission chosen by coincidence may also be so close to each other that received signals are interpreted as response signals.

What is disadvantageous, too, is that after emitting a test signal one has to work with a time frame within which it is possible to recognize a signal as response signal. This increases the technical expenditure and the system's susceptibility to failure. Furthermore, this time frame and the signal propagation time or the signal processing time limit the maximum length of the transmission link.

For test or examination purposes, a transmitting and receiving station of this kind may also be switched to the loop mode (it may be “looped”). Here, for example, the optical input port is directly connected with the optical output port in such a way that a signal received is sent back in the same direction without any evaluation or regeneration. A loop of this kind may also be switched in such a way that optical signals received are first converted into electric signals and then back into optical signals again before they are sent back in the same direction again. Finally, in a looped circuit, it is also possible to electrically regenerate signals received with respect to the clock recovery and the bit pattern, before the signals are sent back again. In the loop mode, however, the signal received is usually not examined or evaluated. A looped circuit of a second transmitting and receiving device, which is connected with a first transmitting and receiving device, may be advantageous for measuring properties of the transmission link such as the propagation time or the signal-to-noise-ratio, for example.

The testing method for checking the operativeness of a transmission link according to the prior art also works if one station is switched to the loop mode, because the test signal received is then sent back directly as a response signal.

The object of the invention is to provide an improved method of checking the operativeness of an optical transmission link which is easy to realize, which reliably detects the operativeness, and which also functions if one of the two stations is switched to the loop mode. Furthermore, it is intended that no limitation of the maximum length of the link is required with the method according to the invention.

Another object of the invention is to provide a device for carrying out this method.

The invention achieves this object with the features of claim 1 and of claim 10.

The invention is based on the idea that it is advantageous if a response signal differs from a test signal with respect to a property to be evaluated, which means that it does not contain at least one property of the test signal (such as the signal duration). Thus, a misinterpretation of a test signal as response signal can easily be avoided. Advantageously, it is therefore possible to reliably check the operativeness of the transmission link. Due to the fact that the signals can be clearly and easily differentiated, it is advantageously not necessary to provide a time frame, either, within which a response signal has to be received after emitting a test signal. What is also advantageous is that, in spite of the different properties of test signals and response signals, it is possible to carry out the method if one station is switched to the loop mode, as will be apparent from the following description. Finally, the method has the advantage that it is not necessary to determine the point of time when a test signal is emitted by coincidence.

According to the invention, a first transmitting and receiving device comprises, in a generally known way, a transmitting unit, a receiving unit, a signal regeneration unit and an evaluation and control unit. After an interruption of transmission, the evaluation and control unit triggers the transmitting unit in such a way that the latter introduces a signal into the transmission link in the direction of a second transmitting and receiving device of the same kind with a specific repetition rate, for example. The signal may be an applied data signal intended for normal transmission, a (in absence of data signal) permanently applied idle signal or a signal generated by the evaluation and control unit. This signal has the nature of a test signal. If the transmission link is operative in the direction of and up to the second transmitting and receiving device, this signal will arrive in the receiving unit of the second transmitting and receiving device. The evaluation and control unit of the second transmitting and receiving device evaluates this test signal. The signal may be evaluated in regenerated or amplified form, or it may be evaluated without having been changed.

The evaluation and control unit of the second transmitting and receiving device evaluates the test signal as such and triggers the transmission unit of the second transmitting and receiving device to send back a signal. This signal, too, may be a an applied data signal intended for normal transmission, a permanently applied idle signal or a signal generated by the evaluation and control unit. What is important is that it differs from the test signal with respect to the property which is evaluated by an evaluation and control unit. This signal has the nature of a response signal.

If the transmission link back to and up to the first transmitting and receiving device is operative, this response signal arrives in the receiving unit of the first transmitting and receiving device. The evaluation and control unit of the first transmitting and receiving device compares the property of the signal received with a predetermined set value or range of set values. If the evaluation and control unit of the first transmitting and receiving device detects that these values correspond with each other, it will interpret the signal received as a response signal to its test signal. Hereby, the operativeness of the transmission link is recognized. The transmission of the data intended to be emitted can start. This analogously applies to the second transmitting and receiving device, which also compares each signal received with a predetermined set value or range of set values with respect to its property and, as the case may be, interprets it as a response signal. In principal, a response signal is always triggered by a signal received which is usually—but not necessarily—a test signal.

Thus, what is important is that, with the aid of at least one different property of the test signal and the response signal, it can be recognized that a response signal received was only emitted by the other station because the latter has received a test signal itself. It is therefore not possible to confuse a response signal with a test signal.

In an embodiment of the invention, the property of the response signal to be evaluated is the duration thereof. If, for example, a response signal is determined as such if the duration thereof exceeds the duration of a test signal by a predetermined value, the two signals differ from each other in this property and cannot be confused. Advantageously, it is unimportant which bit pattern the signals have, because this property does not have to be evaluated. Thus, a fragment of a signal intended for normal transmission may be used for generating the test signal or the response signal irrespective of the contents thereof which are defined by its bit pattern.

In another embodiment of the invention, the bit pattern of the response signal differs from the bit pattern of the test signal. For example, this can be realized in that the evaluation and control unit generates a test signal and a response signal with specific, but different bit patterns and supplies them to the respective transmitting unit to emit them. A set bit pattern deposited in the evaluation and control unit is compared for correspondence with signals received so that the arrival of a response signal can be recognized. Advantageously, this makes it superfluous to evaluate the duration of the signal.

In another embodiment of the invention, the response signal is sent back immediately at the beginning of a reception signal detected. The signal received is evaluated while or after the response signal is or has been sent back. If the evaluation should reveal that the signal received was not a test signal, but already a response signal, the evaluation and control unit can immediately start with the transmission of the data to be transmitted subsequent to the response signal it has already emitted itself. This has the advantage that time is saved, because evaluation takes place simultaneously when the response signal is emitted. Thus, a transmitting and receiving device will quickly receive a response signal to the test signal emitted—leaving signal propagation time in the transmission link out of consideration.

In another embodiment of the invention, the test signal is only emitted if a signal to be emitted is applied to the transmitting and receiving device. Hereby, the check of the transmission link is advantageously only initiated if there is really a need to send data from this transmitting and receiving device to another transmitting and receiving device.

In a preferred embodiment of the invention, a signal to be transmitted is always applied to the transmitting and receiving device, which can advantageously also be used for creating a test signal or a response signal.

In another embodiment of the invention, the emission of a test signal or a response signal can also be triggered manually, which advantageously gives the staff more possibilities to have influence on the transmitting and receiving device.

In an embodiment of the device for carrying out the method, the transmitting and receiving device comprises two transmitting units, two receiving units and one evaluation and control unit. The first transmitting unit receives signals emitted by a first station A which are then regenerated or amplified within the transmitting and receiving device so as to be sent to a second station B in the same first direction via the second transmitting unit. Analogously, the second receiving unit receives signals from this second station B which are regenerated or amplified within the transmitting and receiving device, too, so as to be sent to the first station A via the first transmitting unit. In this case, the transmitting and receiving device is a component in a chain of transmitting and receiving devices. Here, the communication with the first or the second station may be either optical or only electric data transmission.

Each of the two transmitting units within the transmitting and receiving device may comprise a signal regeneration unit which carries out the clock recovery or the regeneration of exact signal forms.

In another embodiment of the invention, the transmitting and receiving device comprises an interconnection unit. This interconnection unit comprises controllable switches and is triggered by the evaluation and control unit in order to suitably connect the four units for transmission and reception or to disconnect them. In order to allow data to pass from the first receiving unit to the second transmitting unit or from the second receiving unit to the first transmitting unit, these units are interconnected by the interconnection unit. However, if one half of the transmitting and receiving device is to be switched to the loop mode, the interconnection unit is triggered by the evaluation and control unit in such a way that it connects the corresponding units (the first receiving unit with the first transmitting unit or the second receiving unit with the second transmitting unit).

In a further embodiment of the invention, the transmitting and receiving device comprises one monitoring unit for each receiving unit. This monitoring unit monitors the input port of the transmitting and receiving device to check whether a signal to be emitted is present or whether there is some line trouble such as a line rupture. Line trouble, for example, may be defined to exist if no signal arrives in the transmitting and receiving device within a predetermined period of time. The monitoring unit reports such line trouble to the evaluation and control unit by means of a trouble signal in order to immediately interrupt the transmission of data and to bring the transmitting and receiving device into the check mode for the checking process. The monitoring unit may also be part of the receiving unit or the evaluation and control unit; furthermore, the trouble signal may be generated within the two receiving units.

In a further embodiment of the invention, test signals and response signals are generated by the respective evaluation and control unit and are not generated from those signals S3, S4 which are applied to the respective transmitting and receiving device for normal data transmission.

Further advantageous embodiments of the invention are apparent from the subclaims.

In the following, the invention is described with the aid of the embodiment illustrated in the drawings, in which:

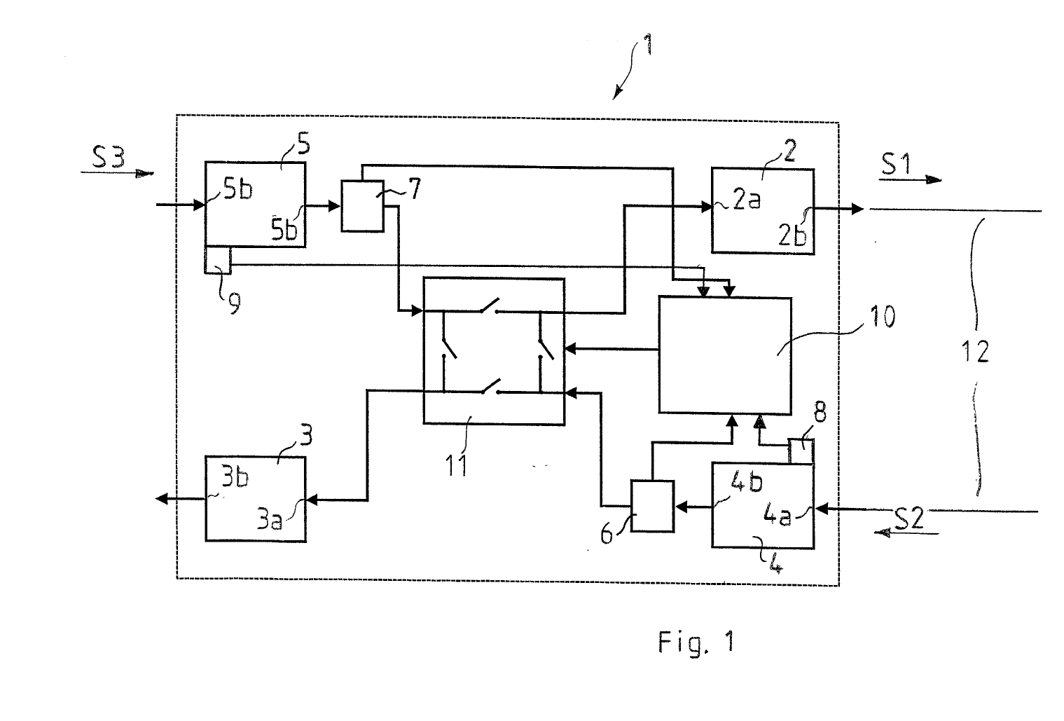

FIG. 1 shows a schematic view of a signal transmission device; and

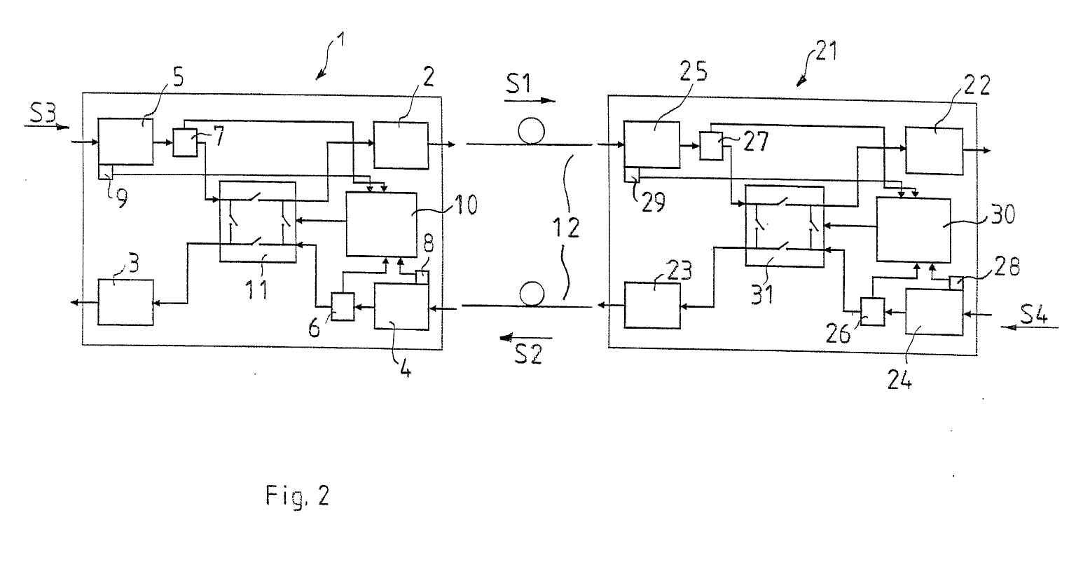

FIG. 2 shows a schematic view of a connection of two signal transmission devices.

As can best be seen in FIG. 1, the signal transmission device 1 comprises a first receiving unit 4 and a second receiving unit 5. The receiving unit 4 has an input port 4a and an output port 4b. The receiving unit 5 has an input port 5a and an output port 5b, as well. The first receiving unit 4 is connected to a first signal regeneration unit 6 with the output port 4b thereof. The second receiving unit 5 is connected to a second signal regeneration unit 7 with the output port 5b thereof. Furthermore, a first monitoring unit 8 is assigned to the receiving unit 4. A second monitoring unit 9 is assigned to the receiving unit 5.

The two signal regeneration units 6, 7 are connected with an interconnection unit 11. Furthermore, a connection exists between each signal regeneration unit 6, 7 and an evaluation and control unit 10. Moreover, a connection exists between the monitoring units 8 and 9 and the evaluation and control unit 10. In turn, the evaluation and control unit is connected with the interconnection unit 11.

Furthermore, the transmitting and receiving device 1 comprises a first transmitting unit 2 and a second transmitting unit 3. The first transmitting unit 2 has an input port 2a and an output port 2b. The second transmitting unit 3 has an input port 3a and an output port 3b. The first transmitting unit 2 is connected to the interconnection unit with the input port 2a thereof. The second transmitting unit 3 is connected to the interconnection unit with the input port 3a thereof, too.

The transmitting units 2, 3 comprise one electric/optical converter, respectively, which is not illustrated in the drawings. This converter converts electric signals which are applied at the input ports 2a and 3a into optical signals which are applied at the output ports 2b and 3b of the transmitting units 2 and 3. The transmitting unit 2 is connected to a transmission link 12 with the optical output port 2b thereof.

The receiving units 4, 5 comprise one optical/electric converter, respectively, which is not illustrated in the drawings. This converter converts optical signals which are applied at the input ports 4a and 5a into electric signals which are applied at the output ports 4b and 5b of the receiving units 4 and 5. The receiving unit 4 is connected to the signal transmission link 12 with the optical input port thereof.

The signal regeneration units 6 and 7 receive electric signals from the output ports 4b and 5b of the receiving units 4 and 5. The signal regeneration units 6 and 7 regenerate these electric signals with respect to their clock frequency and the signal form and transmit them to the interconnection unit 11. Furthermore, each signal regeneration unit 6 and 7 transmits regenerated or non-regenerated signals to the evaluation and control unit 10.

The monitoring units 8 and 9 may utilize the signals which are converted in the receiving units 4 and 5. Here, the monitoring units 8 and 9 may utilize both optical and electric signals. These monitoring units 8 and 9 monitor the respective receiving unit 4, 5 with respect to the presence of an optical signal received. If no such signal is received, the monitoring unit 8 or 9 generates a trouble signal which is transmitted to the evaluation and control unit 10.

In the interconnection unit 11, the regenerated electric signals emitted by the signal regeneration units 7 and 8 are received. In the interconnection unit 11, these signals can optionally be transmitted to the transmitting units 2 or 3. Thus, the electric signals of the signal regeneration unit 7 can be transmitted both to the transmitting unit 2 and to the transmitting unit 3. Accordingly, the electric signals of the signal regeneration unit 6 can be transmitted both to the transmitting unit 2 and to the transmitting unit 3.

The evaluation and control unit 10 chooses the transmitting and receiving devices to be connected, and it also triggers the interconnection unit 11 accordingly. This is done on the basis of the signals which are received in the evaluation and control unit 10 from the signal regeneration units 6 and 7 or from the monitoring units 8 and 9 and are evaluated there.

Furthermore, a signal generated in the evaluation and control unit 10 can be transmitted to the interconnection unit 11 in such a way that it is further transmitted to a transmitting unit 2 or 3 from there.

FIG. 2 shows a connection of two transmitting and receiving devices of the same kind. The left half of FIG. 2 shows the transmitting and receiving device 1 in the form described above. The right half of FIG. 2 shows an additional transmitting and receiving device 21.

The transmitting and receiving device 21 is identical with the transmitting and receiving device 1 as far as its construction and the way it functions are concerned. The transmitting and receiving device 21 comprises two receiving units 24 and 25 which correspond to the receiving units 4, 5 of the first transmitting and receiving device 1. Furthermore, the transmitting and receiving device 21 comprises two transmitting units 22 and 23 which correspond to the transmitting units 2, 3 of the first transmitting and receiving device 1.

Moreover, analogously to the transmitting and receiving device 1, the transmitting and receiving device 21 comprises two monitoring units 28 and 29 and two signal regeneration units 26 and 27. The transmitting and receiving device 21 also comprises an evaluation and control unit 30 and an interconnection unit 31.

The transmitting and receiving device 1 is connected with the transmitting and receiving device 21 via the transmission link 12. The optical output port 2b of the transmitting unit 2 is connected with the optical input port of the receiving unit 25. Furthermore, the optical output port of the transmitting unit 23 is connected with the optical input port 4a of the receiving unit 4. The transmission link 12 may be realized by one or several optical waveguides, for example.

The method of checking the operativeness of the transmission link 10 works as follows:

In case of normal communication between the two transmitting and receiving devices 1 and 21, optical signals arrive at the respective receiving units 4 and 25. This is noticed by the monitoring units 8 and 29, and it is thus recognized that there is no line trouble. The optical signals received are converted into electric signals in the receiving units 4 and 25 and are transmitted to the signal regeneration units 6 and 27. From there, they are transmitted to the interconnection units 11 and 31, respectively; there, they are guided in such a way that the flow of signals basically maintains its direction. This means that the signals received at the receiving unit 4 are transmitted to the transmitting unit 3 in the interconnection unit 11 and that the signals received at the receiving unit 25 are transmitted to the transmitting unit 22 in the interconnection unit 31. Thus, in this normal operating state, signals received are regenerated and are further transmitted in the same direction.

In case of line trouble, the flow of signals from the transmitting and receiving device 1 to the transmitting and receiving device 21 or vice versa or in both directions is interrupted. The absence of a signal at the input port of the receiving units 4 and 25 is noticed by the monitoring unit 8 or 29 and is reported to the evaluation and control unit 10 or 30 with a trouble signal. Then, the evaluation and control unit 8 or 30 triggers the interconnection unit 11 or 31 in such a way that the transmitting unit 2 or 23 is disconnected from signal transmission. Thus, no electric signals are converted into optical signals, and they are not emitted into the transmission link 12 any more. Then, if no signal is received at the associated other station, either, this station stops transmission to the other station, as well.

After the transmission of data has been stopped in this way, the two transmitting and receiving devices are in the check mode. In this check mode, the process of checking the operativeness of an optical transmission link is started.

In the following, let us suppose that some line trouble has occurred in the transmission link 12. Let us furthermore suppose that a signal S3 to be transmitted is still applied to the transmitting and receiving device 1 at the optical input port of the receiving unit 5, but that it is not connected to the transmitting unit 2 by the interconnection unit 11 any more. Let us also suppose that a signal S4 to be emitted is still applied to the receiving unit 24 of the transmitting and receiving device 21, but that transmission to the transmitting unit 23 has been stopped. Finally, let us suppose that the failure in the transmission link 12 has been repaired, so communication is principally possible again.

To emit a test signal S1, the evaluation and control unit 10 triggers the interconnection unit 11 in such a way that the latter establishes the connection between the receiving unit 5 and the transmitting unit 2 for a time period of one millisecond, for example. Hereby, the signal S3 is transmitted to the transmitting unit 2, which introduces the signal into the transmission link 12 in the direction of the second signal transmission device 21.

If the transmission link 12 is operative in the direction from the transmitting unit 2 to the receiving unit 25, the test signal S1 reaches the receiving unit 25 and the subsequent signal regeneration unit 27. The evaluation and control unit 30 recognizes the arrival of the test signal S1 and now takes the necessary steps to send back a response signal S2 in the direction of the signal transmission device 1 in order to confirm to the latter that the test signal S1 has been received.

The response signal S2 is now generated in the same way as the test signal S1. For this purpose, the evaluation and control unit 30 triggers the interconnection unit 31 in such a way that the signal S4 to be transmitted is transmitted to the transmitting unit 23 for a time period which is different from the time period of the test signal (three milliseconds, for example).

The electric signal received in the transmitting unit 23 is now converted into an optical signal and is sent back into the transmission link 12 in the direction of the signal transmission device 1.

If the transmission link 12 is operative in the direction from the transmitting unit 23 to the receiving unit 4, this response signal S2 reaches the receiving unit 4 and the subsequent signal regeneration unit 6. Then, the evaluation unit 10 recognizes that a signal has arrived which is now evaluated with respect to a predetermined property (in this case, the duration of the signal) and is compared with a set value or range of set values (such as 2 ms) deposited. If the duration of the response signal received exceeds this set value of 2 ms, the evaluation and control unit 10 recognizes this signal as a response signal to the test signal S1 emitted before. Thus, the operativeness of the transmission link 12 has been checked successfully.

After the evaluation and control unit 10 has checked the operativeness of the transmission link 12 as described above, the transmitting and receiving device 1 resumes normal communication. For this purpose, the evaluation and control unit 10 triggers the interconnection unit 11 in such a way that the signal S3 to be emitted now is applied to the transmitting unit 2 again, so the latter introduces the signal into the transmission link 12 in the direction of the signal transmission device 21.

After the second signal transmission device 21 has emitted the response signal S2, it now receives the data S3 intended to be transmitted with the receiving unit 25. In the signal regeneration unit 27, the data are regenerated and are transmitted to the interconnection unit 31 and to the evaluation and control unit 30. Now, the evaluation and control unit 30 recognizes that the duration of the signal received exceeds the time of two milliseconds. Thus, the signal received is interpreted as a response signal, which indicates to the signal transmission device 21 that the transmission link 12 is operative. Then, with the interconnection unit 31, the evaluation and control unit 30 switches the signal 4 to be emitted through to the transmitting unit 23. From there, it is introduced into the transmission link 12 in the direction of the transmitting and receiving device 1. Thereby, normal data traffic between the signal transmission device 1 and the transmitting and receiving device 21 is restored.

In the example described above, the criterion for differentiating between the test signal S1 and the response signal S2 was their duration, respectively. Here, the response signal S2 differed from the test signal S1 in that it exceeded a specific period of time of two milliseconds, for example, whereas the test signal S1 had a duration of not more than one millisecond, for example. Of course, the fact that a set value is not reached is also conceivable as a possible criterion.

Thus, as the respective evaluation and control unit 10 or 30 can differentiate between a test signal and a response signal, there is no danger any more that a test signal received is interpreted as a supposed response signal.

The testing method also works if one of the two transmitting and receiving devices 1 or 31 has been switched to the loop mode. Let us assume that the transmitting and receiving device 21 was looped in such a way that the signals received in the receiving unit 25 are directly transmitted to the transmitting unit 23 via the interconnection unit 31, and the transmitting unit then sends them back into the transmission link again. If the transmitting and receiving device 1 now sends a test signal S1 towards the transmitting and receiving device 21 after line trouble, this signal with its duration of one millisecond is immediately sent back to the transmitting and receiving device 1 without being evaluated by the evaluation and control unit 30. So, the test signal S1 arrives at the receiving unit 4 of the transmitting and receiving device 1 again without having been changed. The evaluation and control unit 10 recognizes this signal received as a test signal and causes the transmitting unit 2 to emit a response signal with a duration of three milliseconds by switching through a signal S3 in the interconnection unit 11. If the transmission link 12 is operative, this response signal is received in the signal transmission device 21, too, and is sent back directly to the receiving unit 4 of the signal transmission device 1. Now, the evaluation and control unit 10 recognizes a response signal received and, as described before, starts to emit the signal S3 to be transmitted by connecting the receiving unit 5 with the transmitting unit 2 accordingly. Hereby, the transmission link may now be examined with respect to the signal propagation time or signal changes, for example.

In another embodiment, a signal received is replied to with a response signal immediately at the beginning of detection of the reception of the signal. No sooner than while or after the response signal is or was emitted will the corresponding evaluation and control unit evaluate the signal received. If the evaluation of the signal received reveals that it was not a test signal S1, but a response signal S2, the corresponding evaluation and control unit can initiate the transmission of the regular data to be transmitted, immediately after it has emitted the response signal.

1. A method of checking the operativeness of an optical transmission link (12) wherein, after line trouble or interruption of transmission
a) a first signal transmission device (1) transmits a test signal (S1) to a second signal transmission device (21) via said transmission link (12), and
b) said second signal transmission device (21) sends back a response signal (S2) to said first signal transmission device (1) via said transmission link (12) when it has received said test signal (S1), and
c) said first signal transmission device (1) evaluates at least one property of said response signal (S2) and compares it with a set value or range of set values for the at least one property known to the device, and
d) if a complete or sufficient correspondence of the at least one property evaluated with the predetermined set value or range of set values is detected, recognizes the operativeness of the signal transmission link (12) and starts with the transmission of the signal (S3) to be sent,
characterized in that
e) said test signal (S1) and said response signal (S2) differ from each other with respect to the at least one property evaluated.

2. A method according to claim 1, characterized in that said at least one property is the duration of the response signal (S2).

3. A method according to claim 2, characterized in that the duration of the response signal (S2) is longer than that of the test signal (S1).

4. A method according to claim 1, characterized in that said at least one property is a bit pattern of said response signal (S2).

5. A method according to one of claims 1 to 4, characterized in that said response signal (S2) is sent back immediately at the beginning of a reception signal detected.

6. A method according to one of claims 1 to 4, characterized in that said response signal (S2) is only sent back after reception and evaluation of the test signal (S1) received.

7. A method according to claim 6, characterized in that said first signal transmission device (1) sends a response signal (S2) to said second signal transmission device (21) before the transmission of a signal (S3) to be sent is started.

8. A method according to one of claims 1 to 7, characterized in that said test signal (S1) is only emitted if a signal (S3, S4) to be transmitted by said signal transmission device (1, 21) is present.

9. A method according to claim 8, characterized in that said test signal (S1) or said response signal (S2) consists of fragments of the signal (S3) to be transmitted.

10. A transmitting and receiving device (1), particularly an optical converter or repeater amplifier, for optical data transmission,
a) comprising an optical transmitting unit (2) which converts the electric signals into optical signals and which can be connected with a signal transmission link (12) with the output port (2b) thereof, and
b) comprising an optical receiving unit (4) which converts optical signals into electric signals and which can be connected with a signal transmission link (12) with the input port (4a) thereof, and
c) comprising an evaluation and control unit (10) which evaluates a signal provided by the optical receiving unit (4) or by a monitoring unit (8) and which triggers the optical transmitting unit (2), wherein said evaluation and control unit (10)
c1) evaluates the signal provided with respect to the existence of line trouble in said transmission link (12) and, in case line trouble is detected, initiates a check mode of the transmitting and receiving device (1), wherein, in the check mode, said evaluation and control unit (10)
c11) triggers said optical transmitting unit (2) at given points of time in such a way that the latter sends a test signal (S1) to a second optical receiving unit (25) of a second transmitting and receiving device (21) via said transmission link (12), and
c12) evaluates a response signal (S2) expected from a second optical transmitting unit (23) of said second transmitting and receiving device (21) as a reaction to said test signal (S1) to see whether this response signal (S2) corresponds to a predetermined set value or range of set values with respect to at least one property to be evaluated, and
c13) if a complete or sufficient correspondence of said at least one property evaluated with the predetermined set value or range of set values is detected, recognizes the operativeness of said signal transmission link (12), and
c2) if the operativeness is recognized, triggers said optical transmitting unit (2) in such a way that the latter makes it possible to send a signal which is present or to be emitted,
characterized in that
d) said test signal (S1) and said response signal (S2) differ from each other with respect to said at least one property evaluated.

11. A transmitting and receiving device (1, 21) according to claim 10, characterized in that said at least one property of said response signal (S2) emitted by said transmitting unit (2, 23) is the duration thereof.

12. A transmitting and receiving device (1, 21) according to claim 11, characterized in that the duration of said response signal (S2) emitted by said transmitting unit (2, 23) is longer than that of said test signal (S1) emitted by said transmitting unit (2, 23).

13. A transmitting and receiving device (1, 21) according to claim 10, characterized in that said at least one property of said response signal (S2) emitted by said transmitting unit (2, 23) is the bit pattern thereof.

14. A transmitting and receiving device (1, 21) according to one of claims 10 to 13, characerized in that, immediately at the beginning of reception of a reception signal detected, said transmitting and receiving device (1, 21) receiving the signal sends back said response signal (S2) with the corresponding transmitting unit (2, 23).

15. A transmitting and receiving device (1, 21) according to one of claims 10 to 13, characterized in that said transmitting and receiving device (1, 21), which receives a signal with its receiving unit (4, 25), only sends back said response signal (S2) via the respective transmitting unit (2, 23) after it has received and evaluated a test signal (S1).

16. A transmitting and receiving device (1, 21) according to claim 15, characterized in that, before the transmission of the signal (S3) to be sent is started, said transmitting unit (2, 23) sends a response signal (S2) to a second signal transmission device (1, 21).

17. A transmitting and receiving device (1, 21) according to one of claims 10 to 16, characterized in that the respective transmitting unit (2, 23) only emits said test signal (S1) if a signal (S3, S4) to be transmitted by said transmitting and receiving device (1, 21) is present.

18. A transmitting and receiving device (1, 21) according to claim 17, characterized in that said test signal (S1) or said response signal (S2) is created by the evaluation and control unit (10, 30) triggering the respective transmitting unit (2, 23) in such a way that the latter emits said test signal (S1) or said response signal (S2) as a part of a signal (S3, S4) to be emitted.
